(19) United States
(12) Patent Application Publication
(10) Pub. No.: US 2024/0428776 A1
(43) Pub. Date: Dec. 26, 2024

(54) METHOD AND DEVICE FOR SYNTHESIZING SPEECH WITH MODIFIED UTTERANCE FEATURES

(71) Applicant: XINAPSE CO., LTD., Seoul (KR)

(72) Inventors: Jin Beom KANG, Seoul (KR); Jae Seung ROH, Seoul (KR)

(73) Assignee: XINAPSE CO., LTD., Seoul (KR)

(21) Appl. No.: 18/426,728

(22) Filed: Jan. 30, 2024

(30) Foreign Application Priority Data
Jun. 20, 2023 (KR) 10-2023-0078910
Jun. 20, 2023 (KR) 10-2023-0078911
Jun. 20, 2023 (KR) 10-2023-0078912

(51) Int. Cl. G10L 13/033; G06F 3/04847

(52) U.S. Cl. CPC G10L 13/0335; G06F 3/04847

(57) ABSTRACT

Provided are a method and device for synthesizing speech with modified utterance features. The method of synthesizing speech with modified utterance features may include generating an initial embedding vector based on predetermined utterance information, generating a low-dimensional embedding vector by reducing dimensionality of the initial embedding vector by using a predetermined dimensionality reduction technique, adjusting a component value of the low-dimensional embedding vector based on a user input, and generating a modified embedding vector by restoring dimensionality of the low-dimensional embedding vector of which the component value is adjusted.

### CROSS-REFERENCE TO RELATED APPLICATIONS

This application is based on and claims priority under 35 U.S.C. § 119 to Korean Patent Application No. 10-2023-0078910, filed on Jun. 20, 2023, Korean Patent Application No. 10-2023-0078911, filed on Jun. 20, 2023, and Korean Patent Application No. 10-2023-0078912, filed on Jun. 20, 2023, in the Korean Intellectual Property Office, the disclosure of which is incorporated by reference herein in its entirety.

### BACKGROUND

### 1. Field

The present disclosure relates to methods and devices for synthesizing speech with modified utterance features. More particularly, the present disclosure relates to methods and devices for synthesizing speech with modified utterance features by reducing and restoring the dimensionality of an embedding vector.

### 2. Description of the Related Art

Recently, with the development of artificial intelligence technology, interfaces using speech signals have become common. Accordingly, researches have been actively conducted on speech synthesis technology that enables synthesized speech to be uttered according to a given situation.

The speech synthesis technology has been applied to many fields, such as virtual assistants, audio books, automatic interpretation and translation, and virtual voice actors, in combination with speech recognition technology based on artificial intelligence.

Various related-art speech synthesis methods include unit selection synthesis (USS) and a hidden Markov model (HMM)-based Speech Synthesis (HTS). The USS method is a method of cutting speech data into phoneme units, storing the phoneme units, retrieving phonemes suitable for an utterance in speech synthesis, and concatenating the retrieved phonemes. The HTS method is a method of extracting parameters corresponding to utterance features to generate a statistical model, and reconstructing text into speech based on the statistical model.

However, the above related-art speech synthesis methods have many limitations in synthesizing natural speech reflecting an utterance style or an emotional expression of a speaker.

Accordingly, recently, a speech synthesis method for synthesizing speech from text based on an artificial neural network has been spotlighted. An artificial neural network-based multi-speaker speech synthesis system synthesizes speech by imitating utterance features of a speaker that are learned.

The multi-speaker speech synthesis system extracts utterance features of a particular speaker as an embedding vector in order to express the utterance features of the speaker in synthesized speech. In an embedding vector, various utterance features are dependent on a plurality of component values, and there is difficulty in directly modifying the component values to express desired utterance features, or understanding the meaning of each element.

Accordingly, in order for a user to express desired utterance features in synthesized speech, there is a need for a technology for synthesizing speech with modified utterance features without the speech synthesis system directly modifying component values of a high-dimensional embedding vector that may be processed.

### SUMMARY

Provided are methods and devices for synthesizing speech with modified utterance features. Technical objectives of the present disclosure are not limited to the foregoing, and other unmentioned objects or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

Additional aspects will be set forth in part in the description which follows and, in part, will be apparent from the description, or may be learned by practice of the presented embodiments of the disclosure.

According to a first aspect of an embodiment, a method of synthesizing speech with modified utterance features includes generating an initial embedding vector based on predetermined utterance information, generating a low-dimensional embedding vector by reducing the dimensionality of the initial embedding vector by using a predetermined dimensionality reduction technique, adjusting a component value of the low-dimensional embedding vector based on a user input, and generating a modified embedding vector by restoring dimensionality of the low-dimensional embedding vector of which the component value is adjusted.

According to a second aspect of the present disclosure, a device for synthesizing speech with modified utterance features includes a memory storing at least one program, and a processor configured to operate by executing the at least one program, wherein the processor is further configured to generate an initial embedding vector based on predetermined utterance information, generate a low-dimensional embedding vector by reducing the dimensionality of the initial embedding vector by using a predetermined dimensionality reduction technique, adjust a component value of the low-dimensional embedding vector based on a user input, and generate a modified embedding vector by restoring the dimensionality of the low-dimensional embedding vector of which the component value is adjusted.

According to a third aspect of the present disclosure, a non-transitory computer-readable recording medium may have recorded thereon a program for executing, on a computer, the method according to the first aspect of the present disclosure.

Other aspects, features, advantages other than those described above will become apparent from the following drawings, claims, and detailed description of the present disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating an operation of a speech synthesis system;

FIG. 2 is a diagram illustrating an embodiment of a speech synthesis system;

FIG. 3 is a diagram illustrating an embodiment of a synthesis unit of a speech synthesis system;

FIG. 4 is a diagram illustrating an embodiment of an artificial neural network-based encoder;

FIG. 5 is a diagram illustrating an embodiment of a vector space for an encoder to generate an embedding vector;

FIG. 6 is a diagram illustrating an embodiment of a speech synthesis system for synthesizing speech with modified utterance features based on a user input;

FIG. 7A is a diagram illustrating an embodiment of reducing the dimensionality of an initial embedding vector and restoring the dimensionality of a low-dimensional embedding vector;

FIG. 7B is a diagram illustrating an embodiment of an interface for modifying utterance features;

FIG. 8 is a flowchart of a method of synthesizing speech with modified utterance features, according to an embodiment;

FIG. 9 is a diagram illustrating an embodiment of synthesizing speech reflecting an emotion by using first utterance information to third utterance information;

FIG. 10 is a diagram illustrating an embodiment of generating an emotional feature difference vector and an emotional utterance embedding vector;

FIG. 11 is a flowchart of a method of synthesizing speech reflecting an emotion, according to an embodiment;

FIG. 12 is a diagram illustrating an embodiment of a speech synthesis system including a first encoder that is trained by using a second encoder;

FIG. 13 is a diagram illustrating an embodiment of a first encoder configured to receive utterance information as input and generate an embedding vector;

FIG. 14 is a flowchart of a method of synthesizing speech of a speaker whose speech is not learned, according to an embodiment; and

FIG. 15 is a block diagram of a device according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As the present disclosure allows for various changes and numerous embodiments, particular embodiments will be illustrated in the drawings and described in detail. Advantages and features of the present disclosure and a method of achieving the same should become clear with embodiments described below in detail with reference to the drawings.

However, the present disclosure is not limited to the embodiments described below, but may be implemented in various forms. In the following embodiments, terms such as “first,” “second,” etc., are used only to distinguish one component from another, and such components must not be limited by these terms. For example, without departing from the scope of the present disclosure, a first component described first may be later described as a second component, and similarly, a second component may also be described as a first component. In addition, a singular expression also includes the plural meaning as long as it is not inconsistent with the context. In addition, the terms “comprises,” “includes,” “has”, and the like used herein specify the presence of stated features or components, but do not preclude the presence or addition of one or more other features or components.

In addition, for convenience of description, the magnitude of components in the drawings may be exaggerated or reduced. For example, the size and thickness of each component illustrated in the drawings are arbitrarily shown for convenience of description, and thus, the present disclosure is not limited to those illustrated in the drawings.

Hereinafter, embodiments of the present disclosure will be described below in detail with reference to the accompanying drawings, and when the embodiments of the present disclosure are described with reference to the drawings, the same or corresponding components are given the same reference numerals, and redundant descriptions thereof will be omitted.

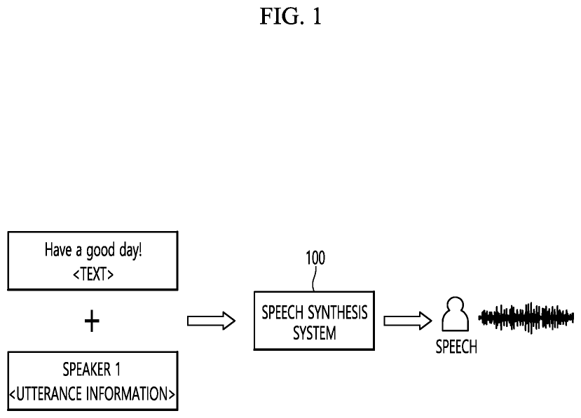

FIG. 1 is a diagram schematically illustrating an operation of a speech synthesis system.

The speech synthesis system is a system for converting text into human speech.

For example, a speech synthesis system 100 of FIG. 1 may be a speech synthesis system based on an artificial neural network. The artificial neural network refers to all models in which artificial neurons constituting a network through synaptic connections have a problem-solving ability by changing the strengths of the synaptic connections through learning.

The speech synthesis system 100 may be implemented with various types of devices, such as personal computers (PCs), server devices, mobile devices, or embedded devices, and may correspond to, as specific examples, smart phones, tablet devices, augmented reality (AR) devices, Internet-of-Things (IoT) devices, autonomous vehicles, robotics, medical devices, electronic book terminals, navigation devices, and the like for performing speech synthesis by using an artificial neural network, but is not limited thereto.

Furthermore, the speech synthesis system 100 may correspond to a dedicated hardware (HW) accelerator to be mounted on the above devices. In some embodiments, the speech synthesis system 100 may be a hardware accelerator such as a neural processing unit (NPU), a tensor processing unit (TPU), or a neural engine, which is a dedicated module for operating an artificial neural network, but is not limited thereto.

Referring to FIG. 1, the speech synthesis system 100 may receive a text input and particular utterance information. For example, as illustrated in FIG. 1, the speech synthesis system 100 may receive “Have a good day!” as a text input, and receive “Speaker 1” as an utterance information input.

“Speaker 1” may correspond to a speech signal or a speech sample representing preset utterance features of speaker 1. For example, the speech synthesis system 100 may receive a speech signal or a speech sample representing the utterance features of speaker 1, as “Speaker 1”. As another example, the speech synthesis system 100 may receive at least one structured data variable corresponding to the utterance features of speaker 1, and in response to the reception, select a speech signal or a speech sample representing the utterance features of speaker 1, from among utterance information pre-stored in a database.

Utterance features of a speaker represented by utterance information may include at least one of various factors such as speech rate, gender, pause period, pitch, tone, prosody, intonation, or emotion.

According to an embodiment, the utterance information may be received from an external device through a communication unit included in the speech synthesis system 100. In some embodiments, the utterance information may be input from a user through a user interface of the speech synthesis system 100, and may be selected as any one of various pieces of utterance information pre-stored in the database of the speech synthesis system 100, but is not limited thereto.

The speech synthesis system 100 may output speech based on the text input and the particular utterance information that are received as input. For example, the speech synthesis system 100 may receive “Have a good day!” and “Speaker 1” as input, and output speech of “Have a good day!” reflecting the utterance features of speaker 1. The utterance features of speaker 1 may include at least one of various elements such as a voice, a prosody, a pitch, and an emotion of speaker 1. That is, the speech output may be speech that sounds as if speaker 1 naturally pronounces “Have a good day!”.

One piece of utterance information may correspond to one speaker. For example, first utterance information may correspond to a speech sample of speaker 1, and second utterance information may correspond to a speech sample of speaker 2. Here, utterance features included in the first utterance information may include a voice, a prosody, and the like of speaker 1, and utterance features included in the second utterance information may include a voice, a prosody, and the like of speaker 2.

In some embodiments, there may be a plurality of pieces of utterance information for one speaker. For example, first utterance information may correspond to a first speech sample of speaker 1 performing an ‘utterance tone of anger’, and the second utterance information may correspond to a second speech sample of speaker 1 performing an ‘utterance tone of joy’. Here, utterance features included in the first utterance information may include the ‘utterance tone of anger’, and utterance features included in the second utterance information may include the ‘utterance tone of joy’.

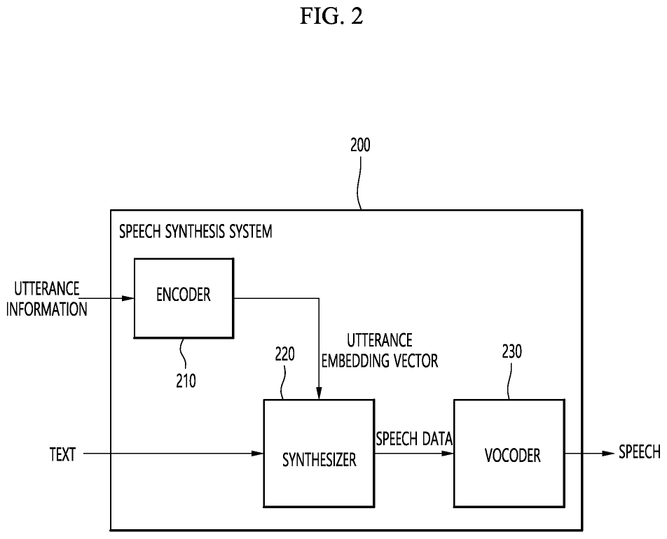

FIG. 2 is a diagram illustrating an embodiment of a speech synthesis system. A speech synthesis system 200 of FIG. 2 may be the same as the speech synthesis system 100 of FIG. 1.

Referring to FIG. 2, the speech synthesis system 200 may include an encoder 210, a synthesizer 220, and a vocoder 230. According to an embodiment, the encoder 210, the synthesizer 220, and the vocoder 230 may be implemented as a functional package within a single program to be executed by one processor, or may be implemented as individual programs to be executed by one processor. According to another embodiment, the encoder 210, the synthesizer 220, and the vocoder 230 may be implemented as individual hardware units, but are not limited thereto. Meanwhile, FIG. 2 illustrates only components of the speech synthesis system 200 that are associated with an embodiment. Thus, it is obvious to those of skill in the art that the speech synthesis system 200 may further include other general-purpose components in addition to the components illustrated in FIG. 2.

According to descriptions to be provided below with reference to FIGS. 2 to 15, at least one component of the speech synthesis system 200 of FIG. 2 may be modified or embodied. Through this, the speech synthesis system 200 may be implemented as a device for synthesizing speech with modified utterance features, a device for synthesizing speech reflecting an emotion, and/or a device for synthesizing speech of a speaker whose speech is not learned.

The speech synthesis system 200 of FIG. 2 may receive utterance information and text as input and output speech.

For example, the encoder 210 of the speech synthesis system 200 may receive utterance information as input and generate an utterance embedding vector. As described above, utterance information may correspond to a speech signal or a speech sample of a speaker. The encoder 210 may receive a speech signal or a speech sample of a speaker, extract utterance features of the speaker, and represent the utterance features as an embedding vector.

In addition, the speech synthesis system 200 may receive, as input, at least one structured data variable representing a particular speaker or particular utterance features. Here, the structured data variable may correspond to the speaker or the utterance features represented by the structured data variable, and the speaker or the utterance features may correspond to particular utterance information including a speech signal or a speech sample. The particular utterance information may include utterance information pre-stored in a database of the speech synthesis system 200.

That is, the speech synthesis system 200 may receive, as input, at least one structured data variable representing a particular speaker or particular utterance features, and obtain particular utterance information corresponding to the structured data variable. Here, the encoder 210 may receive the obtained utterance information, extract utterance features of the speaker, and represent the utterance features as an utterance embedding vector.

In addition, utterance information may be obtained based on a user input. Here, the user input may include an input of at least one structured data variable representing a speaker or utterance features. In addition, the user input may include an input indicating a unique identification value corresponding to a speaker or utterance features. For example, the user may input a user input for selecting a particular speaker to the speech synthesis system 200. In response to the user input, the speech synthesis system 200 may determine a speaker corresponding to the user input, and obtain utterance information corresponding to the determined speaker from the database.

The encoder 210 may represent discontinuous data values included in the utterance information, as a vector including continuous values. For example, the encoder 210 may generate an utterance embedding vector based on at least one or a combination of two or more of various artificial neural network models such as a pre-net, a CBHG module, a deep neural network (DNN), a convolutional neural network (CNN), a recurrent neural network (RNN), a long short-term memory (LSTM) network, or a bidirectional recurrent deep neural network (BRDNN).

The synthesizer 220 of the speech synthesis system 200 may generate speech data based on the utterance embedding vector generated by the encoder 210. For example, the synthesizer 220 of the speech synthesis system 200 may receive, as input, text and an utterance embedding vector representing utterance features of a speaker, and output a spectrogram.

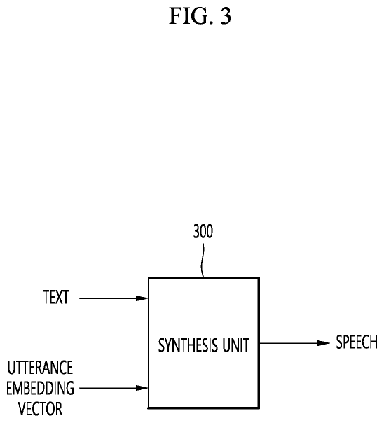

FIG. 3 is a diagram illustrating an embodiment of a synthesis unit of a speech synthesis system. A synthesis unit 300 of FIG. 3 may include the synthesizer 220 and the vocoder 230 of FIG. 2.

Referring to FIG. 3, the synthesis unit 300 of the speech synthesis system 200 may include a text encoder and a decoder. Meanwhile, it is obvious to those of skill in the art that the synthesis unit 300 may further include other general-purpose components in addition to the components illustrated in FIG. 3.

An utterance embedding vector representing utterance features of a speaker may be generated by the encoder 210 as described above, and the encoder or decoder of the synthesis unit 300 may receive the utterance embedding vector representing the utterance features of the speaker from the encoder 210.

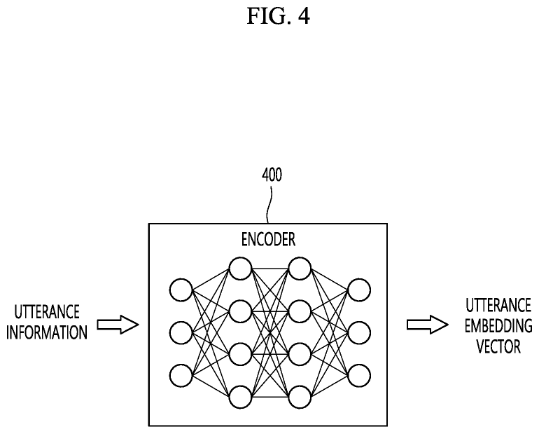

FIG. 4 is a diagram illustrating an embodiment of an artificial neural network-based encoder. An encoder 400 of FIG. 4 may be the same as the encoder 210 of FIG. 2.

Referring to FIG. 4, the encoder 400 may input utterance information into a pre-trained artificial neural network model to output an utterance embedding vector representing utterance features included in the utterance information. The encoder 400 may input utterance information into the artificial neural network model that is trained by using, as utterance information, speech signals or speech samples of speakers. The encoder 400 may map the utterance embedding vector representing the utterance features included in the utterance information, to an embedding space. The artificial neural network model may be at least one of various artificial neural network models such as a pre-net, a CBHG module, a DNN, a CNN, an RNN, an LSTM, or a BRDNN.

The encoder 400 may receive at least one structured data variable as input, and in response to the reception, convert utterance information corresponding to the received structured data variable into an utterance embedding vector by using an artificial neural network including one or more layers of weight matrices. The artificial neural network may include a single embedding layer, a DNN (e.g., a multilayer perceptron (MLP)), and the like.

According to an embodiment, an utterance embedding vector corresponding to utterance information may be pre-stored in the database, and here, the encoder 400 may receive, as input, at least one structured data variable specifying the utterance embedding vector, and obtain the utterance embedding vector from the database.

In addition, the encoder 400 may input preprocessed utterance information into the pre-trained artificial neural network model. According to an embodiment, the encoder 400 may generate first spectrograms by performing a short-time Fourier transform (STFT) on utterance information. The encoder 400 may input the first spectrograms to the pre-trained artificial neural network model to generate an utterance embedding vector.

A spectrogram refers to a visualization of the spectrum of a speech signal in the form of a graph. The x-axis of the spectrogram represents time, the y-axis represents frequency, and the value of a frequency at each time point may be expressed in color according to the magnitude of the value. The spectrogram may be a result of performing an STFT on consecutively provided speech signals.

The STFT refers to a method of dividing a speech signal into sections of a certain length and applying a Fourier transform to each section. Here, because a result of performing an STFT on the speech signal is a complex value, phase information may be lost by taking an absolute value for the complex value, and a spectrogram including only magnitude information may be generated.

In addition, a mel spectrogram refers to a result of re-adjusting a frequency interval of a spectrogram into a mel scale. Human auditory organs are more sensitive in a low frequency band than in a high frequency, and the mel scale expresses the relationship between physical frequencies and frequencies actually perceived by a human, considering such characteristics. A mel spectrogram may be generated by applying a filter bank based on the mel scale to a spectrogram.

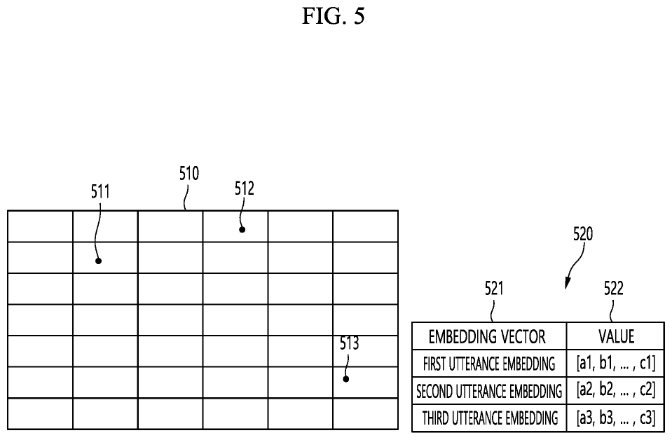

FIG. 5 is a diagram illustrating an embodiment of a vector space for an encoder to generate an embedding vector.

The encoder 400 may display, on a vector space 510, spectrograms corresponding to various pieces of speech data, and embedding vectors corresponding thereto. The encoder 400 may input spectrograms generated from a speech signal or a speech samples of a speaker, into a pre-trained artificial neural network model. The encoder 400 may output, as an utterance embedding vector, an embedding vector of speech data that is most similar to the speech signal or speech sample of the speaker on the vector space 510, from the pre-trained artificial neural network model. That is, the pre-trained artificial neural network model may receive spectrograms as input and generate an embedding vector that matches a particular point in the vector space 510.

The utterance embedding vector generated by the encoder 400 may be mapped to the vector space 510. The vector space 510 may include an embedding space. In general, an embedding space may represent the number of component values of an embedding vector, as a number of dimensions.

For example, the encoder 400 may receive first to third pieces of utterance information as input, and output first to third utterance embedding vectors. Here, the first to third utterance embedding vectors may be mapped to different positions in the vector space 510, respectively. That is, the first to third utterance embedding vectors may correspond to three different points 511, 512, and 513 in the vector space 510.

Meanwhile, the embedding vectors may have component values as much as the number of dimensions of the vector space 510 to which the embedding vectors are mapped. A table 520 may correspond to a mapping table of vector values and embedding vectors corresponding to particular points in the vector space 510. The mapping table may include a list 521 of embedding vectors and a list 522 of vector values.

Referring back to FIG. 3, the text encoder of the synthesis unit 300 may receive text as input and generate a text embedding vector. The text may include a sequence of characters in a particular natural language. For example, the sequence of characters may include alphabetic characters, numbers, punctuation marks, or other special characters.

The text encoder may separate the input text into consonant and vowel units, character units, or phoneme units, and input the separated text into an artificial neural network model. For example, the text encoder may generate a text embedding vector based on at least one or a combination of two or more of various artificial neural network models such as a pre-net, a CBHG module, a DNN, a CNN, an RNN, an LSTM, or a BRDNN.

In some embodiments, the text encoder may separate the input text into a plurality of pieces of short text, and generate a plurality of text embedding vectors for each of the pieces of short text.

The decoder of the synthesis unit 300 may receive, as input, an utterance embedding vector and a text embedding vector from the encoder 400. In some embodiments, the decoder of the synthesis unit 300 may receive an utterance embedding vector as input from the encoder 400 and a text embedding vector as input from the text encoder.

The decoder may input the utterance embedding vector and the text embedding vector into the artificial neural network model to generate a spectrogram corresponding to the input text. That is, the decoder may generate a spectrogram for the input text that reflects utterance features represented by the utterance embedding vector. For example, the spectrogram may correspond to a mel spectrogram, but is not limited thereto.

In addition, although not illustrated in FIG. 3, the synthesis unit 300 may further include an attention module for generating attention alignment. The attention module is a module configured to learn which one of outputs of the encoder at all time-steps an output of the decoder at a particular time-step is most relevant to. By using the attention module, a higher-quality spectrogram or mel spectrogram may be output.

Referring back to FIG. 2, the vocoder 230 of the speech synthesis system 200 may generate actual speech from a spectrogram output from the synthesizer 220. As described above, the output spectrogram may be a mel spectrogram.

In an embodiment, the vocoder 230 may generate an actual speech signal from the spectrogram output from the synthesizer 220, by using an inverse short-time Fourier transform (ISFT). Because a spectrogram or a mel spectrogram does not include phase information, phase information of the spectrogram or mel spectrogram is not considered when generating a speech signal by using an ISFT.

In another embodiment, the vocoder 230 may generate an actual speech signal from the spectrogram output from the synthesizer 220, by using the Griffin-Lim algorithm. The Griffin-Lim algorithm is an algorithm for estimating phase information from magnitude information of a spectrogram or mel spectrogram.

In some embodiments, the vocoder 230 may generate an actual speech signal from the spectrogram output from the synthesizer 220, based on, for example, a neural vocoder.

The neural vocoder is an artificial neural network model configured to receive a spectrogram or a mel spectrogram as input, and generate a speech signal. The neural vocoder may learn the relationship between spectrograms or mel spectrograms and speech signals through a large amount of data, and accordingly, may generate a high-quality actual speech signal.

The neural vocoder may correspond to a vocoder based on an artificial neural network model such as WaveNet, Parallel WaveNet, WaveRNN, WaveGlow, or MelGAN, but is not limited thereto.

For example, the WaveNet vocoder includes multiple dilated causal convolution layers, and is an autoregressive model that uses sequential features between speech samples. The WaveRNN vocoder is an autoregressive model obtained by replacing multiple dilated causal convolution layers of WaveNet with a gated recurrent unit (GRU). The WaveGlow vocoder may be trained to produce a simple distribution such as Gaussian distribution, from a spectrogram dataset (x) by using an invertible transformation function. The completely trained WaveGlow vocoder may output a speech signal from samples of Gaussian distribution by using the inverse function of the transformation function.

Meanwhile, according to an embodiment, the encoder 400 may input utterance information of a speaker into the pre-trained artificial neural network model, to output an embedding vector of speech data that is most similar to the utterance information. Through this, when a speech sample of any speaker is input to the speech synthesis system 200, speech for input text that reflects utterance features of the speaker may be generated. That is, the artificial neural network model of the encoder 400 needs to be trained based on speech data of various speakers, in order to, even when a speech sample of a speaker whose speech is not learned is input, output an embedding vector of speech data that is most similar to the input speech sample of the speaker, as an utterance embedding vector.

For example, training data for training the artificial neural network model of the encoder 400 may correspond to recording data obtained by a speaker performing recording based on a recording script corresponding to particular text. Accordingly, there is a need to evaluate the quality of recording data for training the artificial neural network model of the encoder 400. For example, the quality of the recording data may be evaluated in relation to whether the speaker has performed the recording in accordance with the recording script. The speech synthesis system 200 may be used to evaluate whether the speaker has performed the recording in accordance with the recording script.

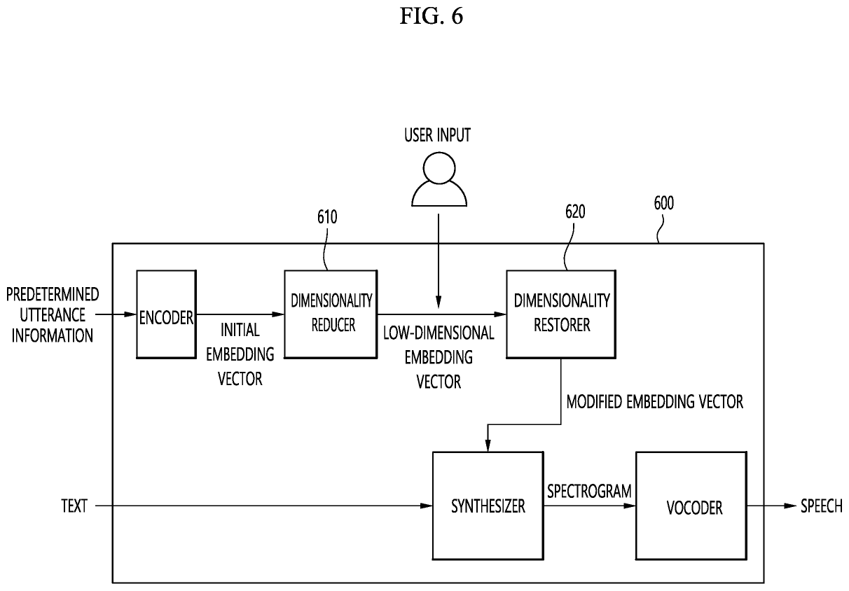

Hereinafter, an example of an operation of a device 600 will be described in detail with reference to FIGS. 6 to 8. The device may be implemented identically to the speech synthesis system 200 illustrated in FIG. 2, but is not limited thereto.

FIG. 6 may be understood as illustrating an embodiment of the device 600 configured to synthesize speech with modified utterance features, and in detail, may show an embodiment of a speech synthesis system for synthesizing speech with modified utterance features based on a user input.

An encoder illustrated in FIG. 6 may be the same as the encoder 210 illustrated in FIG. 2 or the encoder 400 illustrated in FIG. 4. Referring to FIG. 6, unlike the system 200 of FIG. 2, the device 600 may further include a dimensionality reducer 610 and a dimensionality restorer 620. Accordingly, the device 600 may synthesize speech with modified utterance features, and expand the application area of the speech synthesis system.

The device 600 may generate an initial embedding vector based on predetermined utterance information. For example, the device 600 may generate the initial embedding vector by inputting the predetermined utterance information into an artificial neural network model to extract utterance features included in the predetermined utterance information.

The predetermined utterance information may include utterance information obtained from a database based on a user request. For example, the user request may include a low tone and an emotion of sadness. Here, the device 600 may obtain utterance information including a low tone and an emotion of sadness from the database, as the predetermined utterance information.

The initial embedding vector may be included in the utterance embedding vector. As the dimensionality of the utterance embedding vector increases, the device 600 may reflect more detailed utterance features in a speech signal. However, because one utterance feature is associated with a plurality of component values of an utterance embedding vector, the device 600 may reduce the dimensionality of the initial embedding vector of which the component values are difficult to directly adjust.

The device 600 may generate a low-dimensional embedding vector by reducing the dimensionality of the initial embedding vector by using a predetermined dimensionality reduction technique. According to an embodiment, the device 600 may input the initial embedding vector into the dimensionality reducer 610 to generate a low-dimensional embedding vector with fewer component values than the initial embedding vector. The dimensionality reducer 610 may include an algorithm for reducing the number of dimensions of an embedding vector based on a predetermined dimensionality reduction technique. The dimensionality reducer 610 may reduce the dimensionality of an embedding vector by using at least one dimensionality reduction algorithm, or a combination of a plurality of different algorithms.

The low-dimensional embedding vector may be an embedding vector with fewer component values than the initial embedding vector. The component values of the low-dimensional embedding vector may be generated by an operation using at least one of the component values of the initial embedding vector. In addition, because the number of component values of the low-dimensional embedding vector is different from that of the initial embedding vector, the low-dimensional embedding vector may be an embedding vector mapped to a different embedding space.

The predetermined dimensionality reduction technique used by the device 600 may be based on principal component analysis (PCA) using the component values of the initial embedding vector. PCA may refer to a technique for performing a linear transformation on existing component values to generate new component values that are referred to as principal components. The linear transformation may include a linear transformation that preserves the variance of existing component values.

According to an embodiment, PCA may refer to a technique for generating a coordinate system in which, when existing component values are mapped to certain axes, an axis with the greatest variance is a first principal component, and an axis with the second greatest variance is a second principal component. Here, new component values may be generated by performing a linear transformation on the existing component values into the generated coordinate system. One of the generated component values may be understood as a component value in which several component values representing similar utterance features among the existing component values are represented with respect to one principal component.

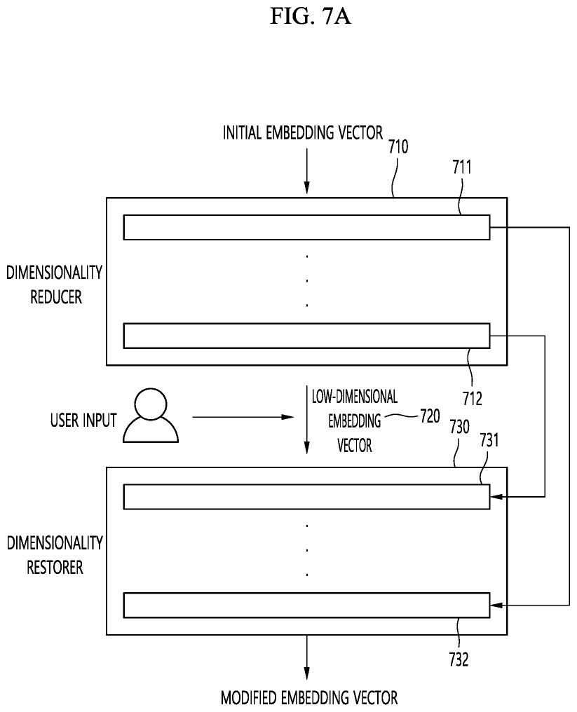

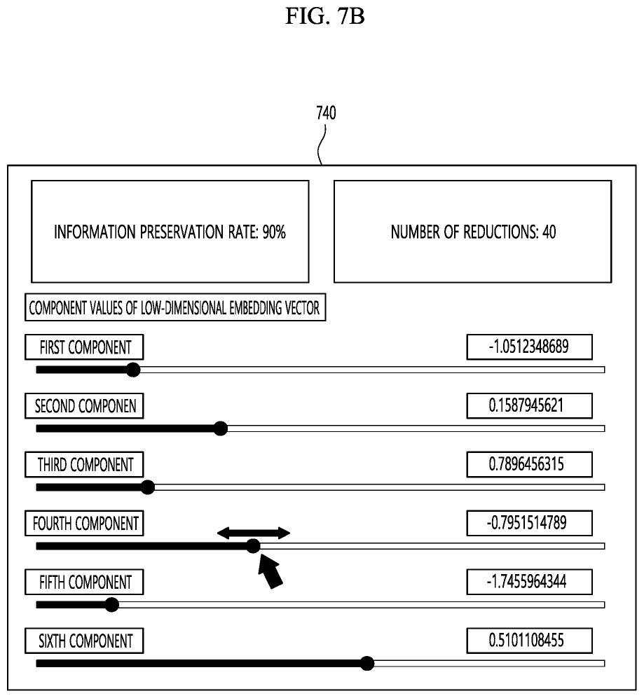

In addition, the number of new component values, that is, the number of principal components, may be arbitrarily set by the user. According to an embodiment, when the number of existing component values is 256, the user may set the number of principal components to 12. That is, the device 600 may be set to receive an initial embedding vector with 256 dimensions and generate a low-dimensional embedding vector with 12 dimensions. According to an embodiment, the device 600 may reduce the dimensionality of the initial embedding vector several times. Reducing the dimensionality of the initial embedding vector several times will be described in detail below with reference to FIG. 7A.

The device 600 may adjust component values of the low-dimensional embedding vector based on a user input. According to an embodiment, the device 600 may receive a user input and in response to the user input, adjust the component values of the low-dimensional embedding vector. For example, based on a user input for adjusting a component value corresponding to the first principal component among the component values of the low-dimensional embedding vector to increase by 10%, the device 600 may adjust the component value corresponding to the first principal component. A detailed embodiment of adjusting component values of a low-dimensional embedding vector based on a user input will be described in detail below with reference to FIG. 7A.

The device 600 may restore the dimensionality of the low-dimensional embedding vector of which the component values are adjusted, to generate a modified embedding vector. According to an embodiment, the device 600 may input the low-dimensional embedding vector into the dimensionality restorer 620 to generate a modified embedding vector having the same number of component values as the initial embedding vector. In addition, the modified embedding vector may be included in an utterance embedding vector.

The predetermined dimensionality reduction technique may include a technique for dimensionality restoration using an inverse operation. The device 600 may perform the inverse operation of an operation of generating a low-dimensional embedding vector by using the predetermined dimensionality reduction technique. The device 600 may generate a modified embedding vector by performing the inverse operation. The dimensionality restorer 620 may include an inverse operation algorithm of the algorithm for reducing the number of dimensions of an embedding vector based on the predetermined dimensionality reduction technique.

The modified embedding vector may be an embedding vector with the same number of component values as the initial embedding vector. The component values of the modified embedding vector may be generated by an operation using at least one of the adjusted component values of the low-dimensional embedding vector. In addition, the initial embedding vector and the modified embedding vector may correspond to utterance embedding vectors corresponding to unmodified utterance features and modified utterance features, respectively. Here, the user input may correspond to modification of utterance features.

The device 600 may generate a speech signal with utterance features that are modified based on text in a particular natural language, predetermined utterance information, and a user input.

The device 600 may generate a modified embedding vector based on predetermined utterance information and a user input. According to an embodiment, the device 600 may generate an initial embedding vector based on predetermined utterance information, and generate a low-dimensional embedding vector based on the initial embedding vector. In addition, the device 600 may adjust component values of the low-dimensional embedding vector based on a user input, and generate a modified embedding vector based on the adjusted low-dimensional embedding vector.

According to an embodiment, the device 600 may generate a spectrogram by inputting a text embedding vector generated based on text and the modified embedding vector into an artificial neural network model. For example, the device 600 may generate a spectrogram by inputting the text embedding vector and the modified embedding vector into the synthesizer 220.

A first speech signal generated based on particular text and an initial embedding vector, and a second speech signal generated based on the particular text and a modified embedding vector may be speech signals reflecting different utterance features. For example, the first speech signal may be a speech signal reflecting utterance features of an ordinary male person, and the second speech signal may be a speech signal reflecting utterance features of an ordinary female person. Here, the user input may be an input signal for modifying utterance features according to gender.

FIG. 7A is a diagram illustrating an embodiment of reducing the dimensionality of an initial embedding vector and restoring the dimensionality of a low-dimensional embedding vector. FIG. 7A is a diagram for describing in detail a process of generating a modified embedding vector by using the initial embedding vector illustrated in FIG. 6. A dimensionality reducer 710 and a dimensionality restorer 730 illustrated in FIG. 7A may correspond to the dimensionality reducer 610 and the dimensionality restorer 620 illustrated in FIG. 6, respectively.

Referring to FIG. 7A, the device 600 may generate a low-dimensional embedding vector 720 by reducing the dimensionality of the initial embedding vector several times based on a predetermined dimensionality reduction technique. According to an embodiment, the device 600 may generate a first reduced vector by reducing the dimensionality of the initial embedding vector, and generate a second reduced vector having fewer dimensions than the first reduced vector by reducing the dimensionality of the first reduced vector. The device 600 may generate the second reduced vector as the low-dimensional embedding vector 720.

The device 600 may input the initial embedding vector into the dimensionality reducer 710 to generate the low-dimensional embedding vector 720. The dimensionality reducer 710 may include a first reduction algorithm 711 and a second reduction algorithm 712. According to an embodiment, the first reduced vector and the second reduced vector may be generated by using the first reduction algorithm 711 and the second reduction algorithm 712, respectively. The first reduction algorithm 711 or the second reduction algorithm 712 may be based on PCA or singular value decomposition (SVD), but is not limited thereto.

For example, the device 600 may input a 512-dimensional initial embedding vector into the dimensionality reducer 710. The dimensionality reducer may generate a 256-dimensional first reduced vector by reducing the dimensionality of the initial embedding vector by using the first reduction algorithm 711. In addition, the dimensionality reducer may generate a 12-dimensional second reduced vector as the low-dimensional embedding vector 720 by reducing the dimensionality of the first reduced vector by using the second reduction algorithm 712.

According to an embodiment, both a process of generating the first reduced vector and a process of generating the second reduced vector may be based on a dimensionality reduction technique using PCA. In some embodiments, the process of generating the first reduced vector and the process of generating the second reduced vector may be based on different dimensionality reduction techniques.

FIG. 7B is a diagram illustrating an embodiment of an interface for modifying utterance features.

Referring to FIG. 7B, the device 600 may adjust component values of the low-dimensional embedding vector 720 based on a user input. A first interface 740 according to an embodiment may include an area for displaying information lost and preserved as dimensionality reduction is performed, and an area for indicating the number of reductions.

According to an embodiment, the device 600 may generate the first interface 740 for displaying the component values of the low-dimensional embedding vector 720, and adjust the component values of the low-dimensional embedding vector 720 in response to receiving a user input through the first interface 740. Here, the user input may be a user input signal for directly adjusting the component values of the low-dimensional embedding vector 720. For example, the user input may be for increasing a component value corresponding to a particular principal component among the component values of the low-dimensional embedding vector 720 by 10%.

According to an embodiment, the first interface 740 may correspond to an interface that provides sliders corresponding to the component values of the low-dimensional embedding vector 720, respectively. Here, a user input may be input to the device 600 by the user adjusting the position of an indicator on the slider. The device 600 may adjust the component values of the low-dimensional embedding vector 720 in response to the user input for adjusting the slider. The first interface 740 is not limited to an interface for displaying a slider.

In some embodiments, the device 600 may map at least one utterance feature extracted from predetermined utterance information, to a component value of the low-dimensional embedding vector 720, and generate a second interface for displaying the mapped utterance feature. The device 600 may adjust the component values of the low-dimensional embedding vector 720 by receiving a user input for adjusting the utterance features through the second interface.

As described above, utterance features may include may include at least one of a speech rate, gender, a pause period, a pitch, a tone, a prosody, an intonation, an emotion, or the like. According to an embodiment, the speech rate may be affected by first to third principal components by a predetermined threshold range or greater. In addition, according to an embodiment, a pitch may be affected by third to fifth principal components by a predetermined threshold range or greater. Here, the device 600 may map the speech rate to component values corresponding to the first to third principal components, and map the pitch to component values corresponding to the third to fifth principal components.

In addition, the device 600 may generate a function value representing a particular utterance feature by using at least one component value of the low-dimensional embedding vector 720 as a factor. According to an embodiment, a speech rate function value may use component values corresponding to the first to third principal components as factors. In addition, a pitch function value may use component values corresponding to the third to fifth principal components as factors.

The device 600 may generate the second interface for displaying the mapped utterance features. For example, the device 600 may generate, as the second interface, an interface for displaying a slider corresponding to each function value representing at least one utterance feature. The second interface is not limited to an interface for displaying a slider.

The device 600 may adjust the component values of the low-dimensional embedding vector 720 by receiving a user input for adjusting the utterance features through the second interface. Here, the user input may correspond to the user's intention to adjust the utterance features. For example, the user input may correspond to the user's intention to increase the speech rate or change the intonation of the speaker.

The device 600 may adjust a component value of the low-dimensional embedding vector 720 to be between a first threshold value and a second threshold value, the first threshold value and the second threshold value being inclusive, based on the user input. Here, the first threshold value may be less than the second threshold value.

According to an embodiment, the first threshold value may correspond to the minimum value of the component value of the low-dimensional embedding vector 720 required to restore the dimensionality of the low-dimensional embedding vector 720 of which the component values are adjusted. The second threshold value may correspond to the maximum value of the component value of the low-dimensional embedding vector 720 required to restore the dimensionality of the low-dimensional embedding vector 720 of which the component values are adjusted.

According to another embodiment, the device 600 may restore the dimensionality of the low-dimensional embedding vector 720, and then synthesize a speech signal by using the modified embedding vector as an utterance embedding vector. The first threshold value or the second threshold value may correspond to the minimum or maximum value of the component value of the low-dimensional embedding vector 720 required to enable speech signal synthesis.

According to another embodiment, the device 600 may generate low-dimensional embedding vectors 720 corresponding to all utterance information previously learned by the encoder 400, and set the first threshold value and the second threshold value based on component values of the generated low-dimensional embedding vectors 720. For example, the first threshold value corresponding to the first principal component may correspond to the minimum value among component values of the generated low-dimensional embedding vectors 720 corresponding to the first principal component.

The device 600 may restore the dimensionality of the low-dimensional embedding vector 720 of which the component values are adjusted, to generate a modified embedding vector. The device 600 may input the low-dimensional embedding vector 720 of which the component values are adjusted, into the dimensionality restorer 730 to generate a modified embedding vector of which the dimensionality is restored.

The predetermined dimensionality reduction technique may include a technique for dimensionality restoration using an inverse operation. The device 600 may generate a modified embedding vector by performing the inverse operation of the operation of generating the low-dimensional embedding vector 720 by using the predetermined dimensionality reduction technique. According to an embodiment, the dimensionality restorer 730 may use the same machine learning model as that used by the dimensionality reducer 710, but perform the operations in reverse order.

For example, the predetermined dimensionality reduction technique may correspond to PCA, which may be based on a linear transformation of existing component values. Here, the predetermined dimensionality reduction technique may include a dimension restoration technique using the inverse operation of the linear transformation.

According to an embodiment, the dimensionality reducer 710 configured to reduce the dimensionality of an initial embedding vector may include the first reduction algorithm 711 and the second reduction algorithm 712. In addition, the dimensionality restorer 730 configured to restore the dimensionality of the low-dimensional embedding vector 720 may include a first restoration algorithm 731 and a second restoration algorithm 732. Here, the operation of the dimensionality restorer 730 may correspond to the inverse operation of the operation performed by the dimensionality reducer 710. For example, the inverse operation of the first reduction algorithm 711 may correspond to the second restoration algorithm 732, and the inverse operation of the second reduction algorithm 712 may correspond to the first restoration algorithm 731.

In addition, the device 600 may reduce the initial embedding vector by using a plurality of dimensionality reduction algorithms and generate a modified embedding vector by using a plurality of dimension restoration algorithms, thereby reducing the amount of data of the initial embedding vector that is lost as the reduction and restoration are performed.

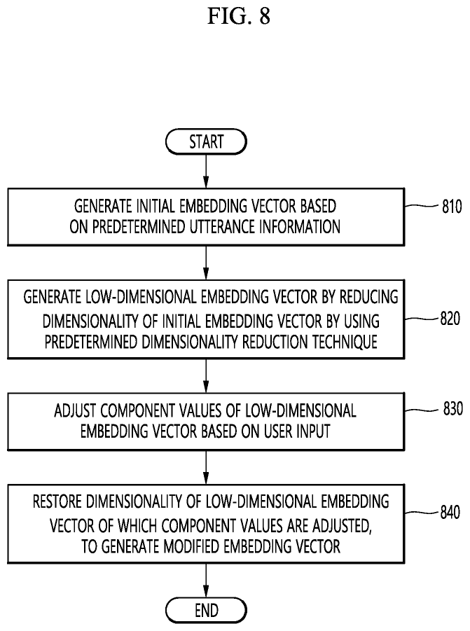

FIG. 8 is a flowchart of a method of synthesizing speech with modified utterance features, according to an embodiment.

Referring to FIG. 8, in operation 810, the device 600 may generate an initial embedding vector based on predetermined utterance information.

In operation 820, the device 600 may generate a low-dimensional embedding vector by reducing the dimensionality of the initial embedding vector by using a predetermined dimensionality reduction technique.

The predetermined dimensionality reduction technique may be based on PCA using component values of the initial embedding vector.

The device 600 may generate a first reduced vector by reducing the dimensionality of the initial embedding vector, and generate a second reduced vector having fewer dimensions than the first reduced vector by reducing the dimensionality of the first reduced vector.

In operation 830, the device 600 may adjust component values of the low-dimensional embedding vector based on a user input.

The device 600 may generate a first interface for displaying the component values of the low-dimensional embedding vector, and adjust the component values of the low-dimensional embedding vector by receiving a user input through the first interface.

The device 600 may map at least one utterance feature extracted from the predetermined utterance information, to a component value of the low-dimensional embedding vector, generate a second interface for displaying the mapped utterance feature, and adjust the component values of the low-dimensional embedding vector by receiving a user input for adjusting the component values of the low-dimensional embedding vector through the second interface.

The device 600 may adjust a component value of the low-dimensional embedding vector to be between a first threshold value and a second threshold value, the first threshold value and the second threshold value being inclusive, based on the user input. Here, the first threshold value may be less than the second threshold value.

In operation 840, the device 600 may restore the dimensionality of the low-dimensional embedding vector of which the component values are adjusted, to generate a modified embedding vector.

The predetermined dimensionality reduction technique may include a technique for dimension restoration using an inverse operation, and the device 600 may generate a modified embedding vector by performing the inverse operation of the operation of generating a low-dimensional embedding vector by using the predetermined dimensionality reduction technique.

The device 600 may generate a speech signal based on text in a particular natural language, and the modified embedding vector.

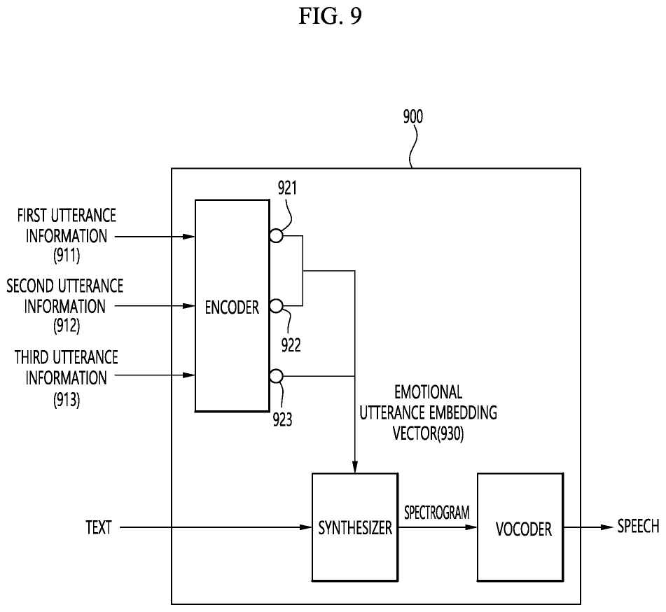

Hereinafter, an example of an operation of a device 900 will be described in detail with reference to FIGS. 9 to 11. The device 900 may be implemented identically to the speech synthesis system 200 illustrated in FIG. 2, but is not limited thereto.

FIG. 9 may be understood as illustrating an embodiment of the device 900 configured to synthesize speech reflecting an emotion, and in detail, may show an embodiment of a speech synthesis system for synthesizing speech reflecting an emotion by using first utterance information to third utterance information.

The device 900 according to an embodiment may synthesize speech reflecting an emotion by using a plurality of pieces of utterance information. Accordingly, the device may reflect an emotion in synthesized speech with little cost and time.

FIG. 9 is a diagram illustrating an embodiment of synthesizing speech reflecting an emotion by using first utterance information to third utterance information. An encoder illustrated in FIG. 9 may be the same as the encoder 210 illustrated in FIG. 2 or the encoder 400 illustrated in FIG. 4.

Referring to FIG. 9, the device 900 may obtain first utterance information 911 and second utterance information 912 for a verbal utterance of a first speaker, and third utterance information 913 for a verbal utterance of a second speaker.

According to an embodiment, there may be utterance information for each speaker. For example, there may be the first utterance information 911 corresponding to utterance features of the first speaker, and the second utterance information 912 corresponding to utterance features of the second speaker.

In some embodiments, according to another embodiment, there may be a plurality of pieces of utterance information for one speaker. For example, there may be the first utterance information 911 corresponding to utterance features of the first speaker performing a tone of sadness, and the second utterance information 912 corresponding to utterance features of the first speaker performing a tone of anger. In addition, there may be the third utterance information 913 corresponding to utterance features of the first speaker performing a tone of dullness without expressing any emotion.

According to an embodiment of the present disclosure, the first and second utterance information 911 and 912 may correspond to utterance information for the first speaker, and the third utterance information 913 may correspond to utterance information for the second speaker.

For example, the first utterance information 911 may include utterance features of the first speaker expressing a predetermined emotion. The second utterance information 912 may include utterance features of the first speaker not expressing the predetermined emotion. The third utterance information 913 may include utterance features of the second speaker not expressing the predetermined emotion.

The predetermined emotion may include joy, sadness, anger, and the like. For example, the predetermined emotion may correspond to ‘sadness’. Here, the first utterance information 911 may include utterance features of the first speaker expressing ‘sadness’, such as a low speech rate or a low pitch, the second utterance information 912 may include utterance features of the first speaker not expressing ‘sadness’, and the third utterance information 913 may include utterance features of the second speaker not expressing ‘sadness’.

As described above, the utterance features may include may include at least one of a speech rate, a pause period, a pitch, a tone, a prosody, an intonation, or the like. For example, the first utterance information 911 may correspond to utterance information including a speech rate and a pitch of the first speaker expressing ‘sadness’. In more detail, the first utterance information 911 may correspond to a speech sample including a speech rate and a pitch of the first speaker expressing ‘sadness’.

The first to third utterance information 911, 912, and 913 may each be selected based on a user input. Here, the user input may include at least one structured data variable representing the first speaker, the second speaker, or the predetermined emotion. In addition, the user input may include an input indicating a unique identification value corresponding to the first speaker, the second speaker, or the predetermined emotion. For example, the user may input, to the device 900, an input for selecting the first speaker, the second speaker, and the predetermined emotion. In response to the user input, the device 900 may determine the first speaker, the second speaker, and the predetermined emotion, and obtain the first to third utterance information 911, 912, and 913 corresponding thereto, from the database.

According to an embodiment, the device 900 may obtain an utterance embedding vector corresponding to utterance information by using an encoder. The utterance embedding vector is obtained by the encoder extracting utterance features included in the utterance information and mapping the utterance features to an embedding space. First to third embedding vectors 921, 922, and 923 illustrated in FIG. 9 may be understood as utterance embedding vectors. That is, the first to third embedding vectors 921, 922, and 923 are utterance embedding vectors, and may be used by the device 900 to impart particular utterance features to a speech signal.

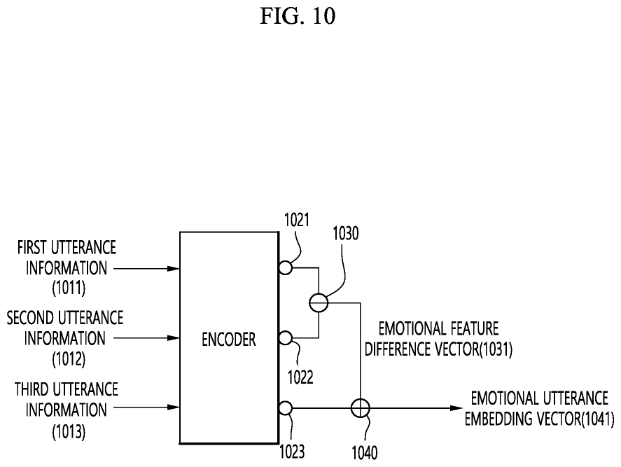

The device 900 may generate an emotional utterance embedding vector 930 based on the first to third utterance information 911, 912, and 913. For example, the device 900 may generate the first embedding vector 921 based on the first utterance information 911, generate the second embedding vector 922 based on the second utterance information 912, and generate the third embedding vector 923 based on the third utterance information 913. Here, the device 900 may generate the emotional utterance embedding vector 930 based on the first to third embedding vectors 921, 922, and 923. The generating of the emotional utterance embedding vector 930 described above will be described in detail below with reference to FIG. 10.

The first to third utterance information 911, 912, and 913 correspond to the first to third embedding vectors 921, 922, and 923, respectively. Thus, according to an embodiment, the device 900 does not generate an embedding vector whenever it synthesizes speech, but may use embedding vectors previously generated based on pieces of utterance information. Here, the device 900 may use predetermined identification information to identify an utterance embedding vector necessary for generating the emotional utterance embedding vector 930. The device 900 may select the first to third embedding vectors 921, 922, and 923 for generating the emotional utterance embedding vector 930, by using the predetermined identification information.

The device 900 may generate the emotional utterance embedding vector 930 by performing a predetermined vector operation on the first to third embedding vectors 921, 922, and 923. The predetermined vector operation may include a linear combination between the first to third embedding vectors 921, 922, and 923.

The device 900 may generate the first to third embedding vectors 921, 922, and 923 based on the first to third utterance information 911, 912, and 913. According to an embodiment, the device 900 may generate the emotional utterance embedding vector 930 based on the first to third embedding vectors 921, 922, and 923. The device 900 may generate a speech signal based on text in a particular natural language, and the emotional utterance embedding vector 930. According to an embodiment, the device 900 may generate a spectrogram by inputting a text embedding vector generated based on the text, and the emotional utterance embedding vector 930 into an artificial neural network model. For example, the device 900 may generate a spectrogram by inputting the text embedding vector and the emotional utterance embedding vector 930 into the synthesizer 220.

A first speech signal generated based on the particular text and the third embedding vector 923, and a second speech signal generated based on the particular text and the emotional utterance embedding vector 930 may be speech signals reflecting different utterance features. According to an embodiment, the first speech signal may be a speech signal that does not reflect utterance features according to the predetermined emotion, and the second speech signal may be a speech signal that reflects utterance features according to the predetermined emotion. Here, both the first speech signal and the second speech signal may be speech signals that imitate speech of the second speaker. In addition, the utterance features according to the predetermined emotion may include utterance features that are exhibited when the first speaker expresses the predetermined emotion. That is, the first speech signal may be a speech signal that imitates speech of the second speaker, excluding the utterance features that are exhibited when the first speaker expresses the predetermined emotion, and the second speech signal may be a speech signal that imitates speech of the second speaker, reflecting the speech features that are exhibited when the first speaker expresses the predetermined emotion.

FIG. 10 is a diagram illustrating an embodiment of generating an emotional feature difference vector and an emotional utterance embedding vector.

Comparing FIG. 9 with FIG. 10, an encoder illustrated in FIG. 10 may be implemented identically to the encoder illustrated in FIG. 9. Hereinafter, an example in which the device 900 generates an emotional feature difference vector 1031 and an emotional utterance embedding vector 1041 will be described in detail with reference to FIG. 10.

First to third utterance information 1011, 1012, and 1013 illustrated in FIG. 10 may correspond to the first to third utterance information 911, 912, and 913 illustrated in FIG. 9, respectively, and first to third embedding vectors 1021, 1022, and 1023 illustrated in FIG. 10 may correspond to the first to third embedding vectors 921, 922, and 923 illustrated in FIG. 9, respectively. In addition, the emotional utterance embedding vector 1041 illustrated in FIG. 10 may correspond to the emotional utterance embedding vector 930 illustrated in FIG. 9.

Referring to FIG. 10, the device 900 may generate the emotional feature difference vector 1031 corresponding to a predetermined emotion expressed by a first speaker, based on the first utterance information 1011 and the second utterance information 1012.

According to an embodiment, the device 900 may extract, as the emotional feature difference vector 1031, changes in an utterance embedding vector according to a difference in emotional expression of a first speaker whose speech is previously learned, and generate the emotional utterance embedding vector 1041 reflecting a predetermined emotion, by applying the changes to an utterance of a second speaker. Here, the predetermined emotion reflected in the emotional utterance embedding vector 1041 corresponds to emotional expression features of the first speaker, and utterance features without the predetermined emotion represented by the emotional utterance embedding vector 1041 may be understood as utterance features of the second speaker.

Based on the first utterance information 1011, the device 900 may generate the first embedding vector 1021 corresponding to utterance features of the first speaker expressing the predetermined emotion. For example, the first utterance information 1011 may include utterance features of the first speaker expressing ‘sadness’. Here, the device 900 may extract the utterance features of the first speaker expressing ‘sadness’ from the first utterance information 1011, to generate the first embedding vector 1021.

Based on the second utterance information 1012, the device 900 may generate the second embedding vector 1022 corresponding to utterance features of the first speaker not expressing the predetermined emotion. For example, the second utterance information 1012 may include utterance features of the first speaker not expressing ‘sadness’. Here, the device 900 may extract the utterance features of the first speaker not expressing ‘sadness’ from the second utterance information 1012, to generate the second embedding vector 1022.

The device 900 may generate the emotional feature difference vector 1031 based on the first embedding vector 1021 and the second embedding vector 1022. The device 900 may generate the emotional feature difference vector 1031 by performing a predetermined extraction operation 1030 on the first embedding vector 1021 and the second embedding vector 1022. The predetermined extraction operation 1030 may include a linear combination of vectors.

In addition, the predetermined extraction operation 1030 may correspond to a method of extracting a contextual meaning of a word in the field of natural language processing. According to an embodiment, the device 900 may generate the emotional feature difference vector 1031 by performing a linear combination between the first embedding vector 1021 and the second embedding vector 1022.

The device 900 may generate a plurality of emotional feature difference vectors by mapping the emotional feature difference vector 1031 to each of a plurality of speakers and each of a plurality of emotions. According to an embodiment, the device 900 may map the emotional feature difference vector 1031 to a plurality of speakers, such as a first speaker and a third speaker, and to a plurality of emotions such as ‘joy’ and ‘sadness’. For example, the device 900 may generate a first emotional feature difference vector corresponding to the first speaker and ‘sadness’. The device 900 may generate a second emotional feature difference vector corresponding to the first speaker and ‘joy’, and a third emotional feature difference vector corresponding to the third speaker and ‘sadness’.

The device 900 may generate a mapping table by using a list of a plurality of speakers, a list of a plurality of emotions, and a list of a plurality of emotional feature difference vectors. For example, the first emotional feature difference vector may be mapped to the first speaker and ‘sadness’. The second emotional feature difference vector may be mapped to the first speaker and ‘joy’. The third emotional feature difference vector may be mapped to the third speaker and ‘sadness’.

The device 900 may select an emotional feature difference vector mapped to the first speaker and a predetermined emotion from among the plurality of generated emotional feature difference vectors, based on a user input. According to an embodiment, the user may input, to the device 900, a signal for selecting the first speaker and a predetermined emotion. Here, in response to the user input, the device 900 may select the first speaker and the predetermined emotion, and select the emotional feature difference vector 1031 mapped to the first speaker and the predetermined emotion. For example, when the first emotional feature difference vector is mapped to the first speaker and ‘sadness’, the device 900 may receive the user input and select the first emotional feature difference vector. The device 900 may receive the user input and obtain the selected first emotional feature difference vector from the database.

Through this, the device 900 may generate, store, and use emotional feature difference vectors 1031 corresponding to all emotions of all speakers that are learned by an artificial neural network model used by the device 900 or the encoder.

The device 900 may generate the emotional utterance embedding vector 1041 in which the predetermined emotion is reflected in utterance features of the second speaker, based on the emotional feature difference vector 1031 and the third utterance information 1013.

Based on the third utterance information 1013, the device 900 may generate the third embedding vector 1023 corresponding to utterance features of the second speaker not expressing the predetermined emotion. For example, the third utterance information 1013 may include utterance features of the second speaker not expressing ‘sadness’. Here, the device 900 may extract the utterance features of the second speaker not expressing ‘sadness’ from the third utterance information 1013, to generate the third embedding vector 1023.

The device 900 may generate the emotional utterance embedding vector 1041 based on the third embedding vector 1023 and the emotional feature difference vector 1031. The device 900 may generate the emotional feature difference vector 1031 by performing a predetermined addition operation 1040 on the third embedding vector 1023 and the emotional feature difference vector 1031. The predetermined addition operation 1040 may include a linear combination of vectors.

In addition, the predetermined addition operation 1040 may correspond to a method of adding a contextual meaning of a word in the field of natural language processing. According to an embodiment, the device 900 may generate the emotional utterance embedding vector 1041 by performing a linear combination between the third embedding vector 1023 and the emotional feature difference vector 1031.

The emotional utterance embedding vector 1041 may be included in an utterance embedding vector. According to an embodiment, the device 900 may input a text embedding vector and the emotional utterance embedding vector 1041 into the artificial neural network model. Here, the device 900 may generate a spectrogram including features of the first speaker expressing the predetermined emotion, and utterance features of the second speaker. That is, the device 900 may generate the emotional utterance embedding vector 1041 in which features that are exhibited when the first speaker expresses the predetermined emotion are reflected in utterance features of the second speaker not expressing the predetermined emotion.

The first to third embedding vectors 1021, 1022, and 1023, the emotional feature difference vector 1031, and the emotional utterance embedding vector 1041 may all be embedding vectors having the same dimensionality. Here, the embedding vectors may be embedding vectors mapped into the same embedding space. The number of dimensions of the embedding space may be arbitrarily set by the user. For example, the embedding space may be set to be 256-dimensional or 512-dimensional.

According to an embodiment, the device 900 may generate the emotional utterance embedding vector 1041 by performing a simple addition-subtraction operation on the first to third embedding vectors 1021, 1022, and 1023 in the same embedding space. Performing the simple addition-subtraction operation between vectors requires significantly less time and amount of computation, making it possible to economically synthesize speech reflecting an emotion.

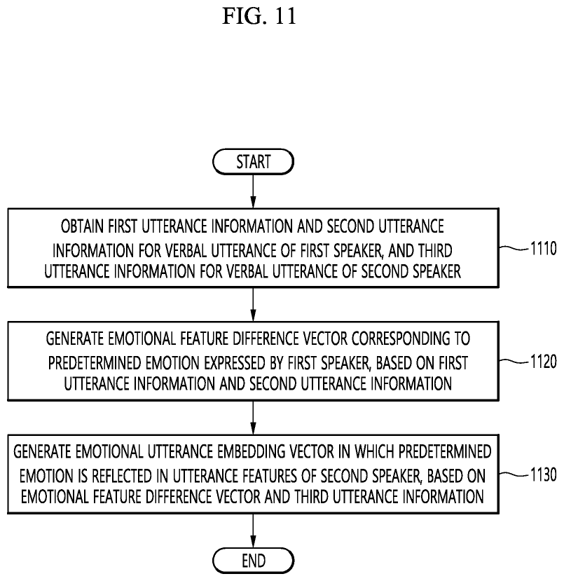

FIG. 11 is a flowchart of a method of synthesizing speech reflecting an emotion, according to an embodiment.

Referring to FIG. 11, in operation 1110, the device 900 may obtain first utterance information and second utterance information for a verbal utterance of a first speaker, and third utterance information for a verbal utterance of a second speaker.

The first utterance information may include utterance features of the first speaker expressing a predetermined emotion.

The second utterance information may include utterance features of the first speaker not expressing the predetermined emotion.

The third utterance information may include utterance features of the second speaker not expressing the predetermined emotion.

In operation 1120, the device 900 may generate an emotional feature difference vector corresponding to the predetermined emotion expressed by the first speaker, based on the first utterance information and the second utterance information.

The device 900 may generate a first embedding vector corresponding to utterance features of the first speaker expressing the predetermined emotion, based on the first utterance information.

The device 900 may generate a second embedding vector corresponding to utterance features of the first speaker not expressing the predetermined emotion, based on the second utterance information.

The device 900 may generate the emotional feature difference vector based on the first embedding vector and the second embedding vector.

The device 900 may generate a plurality of emotional feature difference vectors by mapping the emotional feature difference vector to each of a plurality of speakers and each of a plurality of emotions.

The device 900 may select an emotional feature difference vector mapped to the first speaker and a predetermined emotion from among the plurality of generated emotional feature difference vectors, based on a user input.

In operation 1130, the device 900 may generate the emotional utterance embedding vector in which the predetermined emotion is reflected in utterance features of the second speaker, based on the emotional feature difference vector and the third utterance information.

The device 900 may obtain a third embedding vector corresponding to utterance features of the second speaker not expressing the predetermined emotion, based on the third utterance information.

The device 900 may generate the emotional utterance embedding vector based on the third embedding vector and the emotional feature difference vector.

The device 900 may generate a speech signal based on text in a particular natural language, and the emotional utterance embedding vector.

Related-art speech synthesis methods have many limitations in synthesizing natural speech reflecting an utterance style or an emotional expression of a speaker. Accordingly, recently, a speech synthesis method for synthesizing speech from text based on an artificial neural network has been spotlighted. An artificial neural network-based multi-speaker speech synthesis system synthesizes speech by imitating utterance features of a speaker that are learned.

General techniques that enable a multi-speaker speech synthesis system to synthesize speech reflecting an emotion include a method of training an encoder, based on emotional expressions of a particular speaker, to output speech that sounds as if other speakers express each emotion, a method of using separate encoders configured to process speaker labels and emotion labels, and a method of using a separate module configured to synthesize normal speech and then modulate the speech into emotional speech.

However, there are disadvantages that the methods are limited to only learned voices of speakers and thus incur a cost proportional to the number of voice actors for building a dataset, that the methods require excessive additional components, that expressing one emotion is limited to only one method, and that the overall synthesis speed decreases, and thus, there is a need for a technology for synthesizing speech reflecting an emotion in an economical manner.

According to the method and device for synthesizing speech reflecting an emotion described above with reference to FIGS. 9 to 11, an emotion may be reflected in utterance features simply by calculating an utterance embedding vector and before input to a synthesizer, and thus may be reflected with low cost and fast computation.

In addition, because features of different emotional expressions of each person may be extracted and used, various features of emotional expressions may be added in proportion to training data.

In addition, any speech synthesis system that uses an encoder for extracting utterance features and maps them to an embedding space may universally synthesize speech reflecting an emotion.

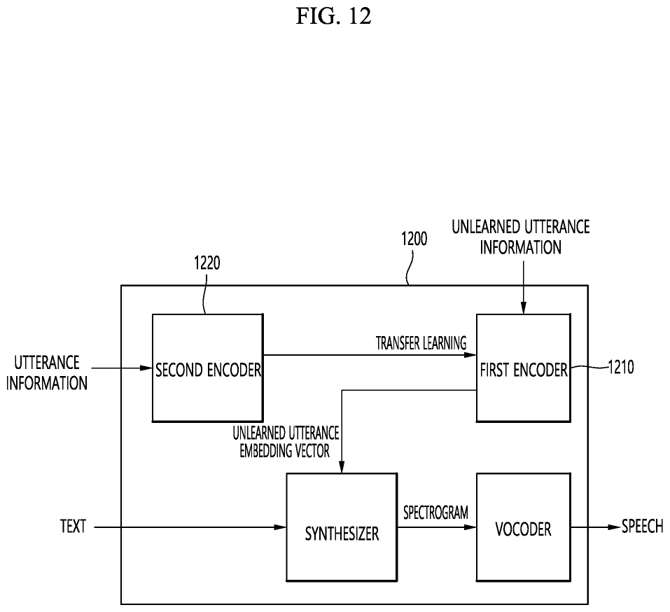

Hereinafter, an example of an operation of a device 1200 will be described in detail with reference to FIGS. 12 to 14. The device 1200 may be implemented identically to the speech synthesis system 200 illustrated in FIG. 2, but is not limited thereto.

FIG. 12 may be understood as illustrating an embodiment of the device 1200 configured to synthesize speech of a speaker whose speech is not learned, and in detail, may show an embodiment of a speech synthesis system including a first encoder that is trained by using a second encoder.

Comparing the device 1200 illustrated in FIG. 12 with the system 200 illustrated in FIG. 2, the device 1200 may include a first encoder 1210 and a second encoder 1220 that are separate from each other. Each of the first encoder 1210 and the second encoder 1220 may perform the operations performed by the encoder described above with reference to FIGS. 1 to 5. That is, the first encoder 1210 or the second encoder 1220 may be the same as the encoder 210 illustrated in FIG. 2, or may be the same as the encoder 400 illustrated in FIG. 4.

According to an embodiment, the first encoder 1210 may be trained by using data output from the second encoder 1220. Through this, the device 1200 may synthesize speech of a speaker whose speech is not learned, by using the trained first encoder 1210.

The device 1200 may obtain unlearned utterance information. The unlearned utterance information may include utterance information that the device 1200 has not previously learned. According to an embodiment, the device 1200 may map utterance embedding vectors corresponding to pieces of previously learned utterance information, to a predetermined embedding space. Here, the unlearned utterance information may correspond to utterance information including utterance features that do not represent the utterance embedding vectors mapped to the predetermined embedding space. In some embodiments, the unlearned utterance information may include a speech samples of a speaker other than those corresponding to the previously learned utterance information. However, the present disclosure is not limited thereto.

According to the related art, in order to synthesize speech of a speaker whose speech is not learned by a pre-trained encoder, a method of fine-tuning the pre-trained encoder may be used. Fine-tuning is a method of training a model by modifying the architecture of the model to suit a new purpose, based on a pre-trained artificial neural network model, and fine-tuning parameters of the pre-trained model.

A pre-trained encoder may use knowledge obtained in a pre-training process, in a fine-tuning process. However, fine-tuning requires updating all parameters of the model, and thus requires a lot of resources in the fine-tuning process. According to an embodiment of the present disclosure, speech of a speaker whose speech is not learned may be synthesized by using a separate encoder that is trained via transfer learning, without fine-tuning.

The device 1200 may generate an unlearned utterance embedding vector by using unlearned utterance information. The unlearned utterance embedding vector may correspond to an utterance embedding vector obtained by inputting unlearned utterance information into an artificial neural network model. That is, the unlearned utterance embedding vector may correspond to an utterance embedding vector used to reflect, in a speech signal, utterance features included in unlearned utterance information.

Generation of the unlearned utterance embedding vector may be performed by the first encoder 1210 that is trained via transfer learning. The first encoder 1210 may have been trained via transfer learning by using information output from the pre-trained second encoder 1220. A model of the first encoder 1210 and/or the second encoder 1220 may be included in the encoder 400. That is, the first encoder 1210 and/or the second encoder 1220 may include an artificial intelligence model based on an artificial neural network configured to receive utterance information as input and outputs an utterance embedding vector.

Hereinafter, a process of training the first encoder 1210 via transfer learning will be described in detail.

Transfer learning refers to a technique for using knowledge obtained for solving a particular problem, to solve another problem. Transfer learning may be performed by transferring knowledge of a pre-trained artificial intelligence model to another artificial intelligence model to be newly used. Here, the pre-trained model may be referred to as a teacher model, and the other artificial intelligence model may be referred to as a student model. According to an embodiment, the first encoder 1210 as a student model may be trained based transfer learning by using the second encoder 1220 as a teacher model.

For example, the transfer learning may be performed by the device 1200. In some embodiments, the transfer learning may be performed by a machine learning system independent of the device 1200. However, the subject performing transfer learning is not limited thereto.

According to an embodiment, the device 1200 may input predetermined utterance information obtained from a preset training database into the first encoder 1210, to generate a feature vector for each of at least one speech frame into which the predetermined utterance information is divided. The predetermined utterance information may correspond to utterance information stored in the training database preset for transfer learning of the first encoder 1210.

The preset training database may include training data for training an artificial neural network model. The training data included in the preset training database may include utterance information, which may include a speech signal, a speech sample, and the like, but is not limited thereto. The training database may include data collected by individuals, companies, and countries.

The speech frame may include a frame obtained by dividing the predetermined utterance information by an arbitrary length. In some embodiments, the speech frame may include a frame obtained by dividing the predetermined utterance information according to a predetermined standard. In some embodiments, the speech frame may include one frame that is the predetermined utterance information itself.

The feature vector may correspond to a vector obtained by extracting and representing features of the speech frame. Feature vectors may be generated as many as the number of speech frames obtained by the division. The feature vector may be generated based on any technique for expressing one speech frame as one vector.

For example, the feature vector may be generated based on a signal processing technique such as mel-frequency cepstral coefficient (MFCC), mel-spectrogram, or linear spectrogram. In some embodiments, the feature vector may be generated based on an artificial neural network. However, the present disclosure is not limited thereto.

According to an embodiment, the device 1200 may obtain a feature vector corresponding to a frame in which speech is present, among at least one speech frame into which the predetermined utterance information is divided. Through this, a feature vector corresponding to a frame in which speech is not present may not be used for learning or inference, and the expected quality of synthesized speech may be improved.

For example, the predetermined utterance information may be divided into first to fourth speech frames, and no speech may be present in the third speech frame. Here, the device 1200 may not obtain third feature vector from among first to fourth feature vectors corresponding to the first to fourth speech frames, respectively, but may obtain only the first to second feature vectors and the fourth feature vector. Meanwhile, according to an embodiment, the device 1200 may obtain a feature vector corresponding to a frame in which speech is present by extracting a fundamental frequency (FO) of the speech.

The device 1200 may input the feature vectors into the first encoder 1210 to obtain frame embedding vectors for the respective feature vectors. According to an embodiment, the device 1200 may obtain a frame embedding vector by inputting a feature vector to the first encoder 1210 using an artificial neural network model.

The frame embedding vector may be included in an utterance embedding vector. For example, the device 1200 may generate a feature vector by extracting utterance features included in a particular speech frame of utterance information. Here, the device 1200 may generate a frame embedding vector having the same dimensionality as the utterance embedding vector, by inputting the feature vector into the artificial neural network model.

The first encoder 1210 according to an embodiment may divide the utterance information into at least one speech frame, extract features of speech included in the speech frame, generate a feature vector for each speech frame, and generate a frame embedding vector for each feature vector in order to map the feature vector to an embedding space. According to an embodiment, because the feature vector may differ from the utterance embedding vector in the number of dimensions and the like, the device 1200 may generate a frame embedding vector based on the feature vector.

The device 1200 may calibrate parameters of the first encoder 1210 by using at least one of a target embedding vector, a frame embedding vector, and a feature vector output by the second encoder 1220 in response to the predetermined utterance information.

The device 1200 may obtain the target embedding vector by inputting the predetermined utterance information into the second encoder 1220. The target embedding vector may be included in the utterance embedding vector. For example, when the predetermined utterance information includes utterance features of a first speaker, the target embedding vector may correspond to an utterance embedding vector used to add utterance features of the first speaker to a speech signal.

The first encoder 1210 may include an artificial neural network model that is not pre-trained. The first encoder 1210 may include a small artificial neural network model to imitate the second encoder 1220.

The device 1200 may calibrate the parameters by using a single loss function or a combination of a plurality of loss function terms. The combination may be performed by weighted-summing a plurality of loss function terms by using loss function weights. Weights that have been proven to provide high learning effectiveness may be set as hyperparameters. According to an embodiment, the device 1200 may calibrate the parameters by using at least one of a perceptual loss function and a triplet loss function. The loss function may refer to a function that compares how far or close a prediction value inferred through an artificial intelligence neural network model is from a target value (a ground-truth value). In general, machine learning may be set to reduce a loss value calculated with a loss function.

The perceptual loss function may include a perceptual loss function used in the field of image super-resolution in the art. The triplet loss function may include a loss function that uses two pieces of data in the same class, one piece of data in another class. The triplet loss function may include a loss function used for training such that output values become closer to each other when data in the same class is input.

The device 1200 may calculate a first loss based on a target embedding vector, a frame embedding vector, and the perceptual loss function. For example, the device 1200 may obtain the first loss by inputting the frame embedding vector as a prediction value and the target embedding vector as a target value into the perceptual loss function that uses the prediction value and the target value as variables.

The device 1200 may generate a frame embedding vector by inputting the predetermined utterance information into the first encoder 1210. The first encoder 1210 may calculate the predetermined utterance information by using parameters of an input layer of the artificial neural network, and generate the frame embedding vector after performing an operation by using parameters of all hidden layers.

The calculation of the artificial neural network may be performed based on a result of preprocessing utterance information. For example, the preprocessing may correspond to division of a speech frame or generation of a feature vector. However, the present disclosure is not limited thereto.

The device 1200 may calculate the first loss based on the frame embedding vector of the first encoder 1210 obtained through forward propagation, a target embedding vector of the second encoder 1220, and the perceptual loss function.

The device 1200 may calibrate parameters based on the calculated first loss. According to an embodiment, the parameters of the first encoder 1210 may be calibrated by performing backpropagation based on the first loss. For example, the device 1200 may perform backpropagation to calibrate the parameters of the first encoder 1210 to reduce a loss value.

The device 1200 may perform forward propagation and backpropagation at least once based on the calibrated parameters. According to an embodiment, the device 1200 may repeat forward propagation and backpropagation a preset number of times. In some embodiments, the device 1200 may repeat forward propagation and backpropagation until the calculated loss value becomes less than a preset error range.

The device 1200 may obtain at least one comparative feature vector by inputting comparative utterance information different from the predetermined utterance information into the first encoder 1210. The comparative utterance information may be obtained from a preset training database. A first speaker corresponding to the comparative utterance information may be different from a second speaker corresponding to the predetermined utterance information.

The feature vector may be understood as being generated by extracting features of a speech frame. Thus, it may be preferable that feature vectors for the same speaker is generated to be far from feature vectors for other speakers in a vector space.

The device 1200 may generate a feature vector by inputting utterance information of the first speaker as predetermined utterance information into the first encoder 1210. The device 1200 may obtain a comparative feature vector by inputting utterance information of a second speaker, who is different from the first speaker, as comparative utterance information into the first encoder 1210.

According to an embodiment, the device 1200 may calculate a second loss based on one comparative feature vector selected from among at least one comparative feature vector, two feature vectors selected from a plurality of feature vectors generated based on the predetermined utterance information, and the triplet loss function. The triplet loss function may include a loss function that uses two vectors in the same class and one vector in another class, as variables. The device 1200 may calculate the second loss by inputting two feature vectors corresponding to the first speaker and one comparative feature vector corresponding to the second speaker, into the triplet loss function.

The device 1200 may calibrate the parameters of the first encoder 1210 based on the calculated second loss. The device 1200 may calibrate the parameters of the first encoder 1210 such that feature vectors for the same speaker are generated to be close to each other in the vector space, and feature vectors for different speakers are generated to be far from each other in the vector space.

Hereinafter, generating an unlearned utterance embedding vector by using the first encoder 1210 that is trained via transfer learning will be described in detail.

The device 1200 may generate an unlearned utterance embedding vector based on unlearned utterance information. According to an embodiment, based on the unlearned utterance information, the device 1200 may generate a feature vector for each of at least one speech frame into which the unlearned utterance information is divided. Generation of a feature vector may be performed in the same manner as a process of generating a feature vector when transfer learning of the first encoder 1210 is performed. The device 1200 may generate an unlearned utterance embedding vector based on the generated feature vector. For example, the device 1200 may generate a frame embedding vector based on the feature vector, and generate an unlearned utterance embedding vector based on the frame embedding vector.

The device 1200 may generate the same number of frame embedding vectors as the number of feature vectors, based on the feature vectors. Generation of a frame embedding vector may be performed in the same manner as a process of generating a frame embedding vector when transfer learning of the first encoder 1210 is performed.

The device 1200 may generate the unlearned utterance embedding vector based on the frame embedding vector. The device 1200 may generate one unlearned utterance embedding vector by using all frame embedding vectors corresponding to one piece of unlearned utterance information.

According to an embodiment, the device 1200 may generate at least one feature vector based on unlearned utterance information, generate a frame embedding vector for each feature vector, and generate an unlearned utterance embedding vector having the mean or median value of all frame embedding vectors.

In some embodiments, the device 1200 may generate a frame embedding vector and generate a higher-quality unlearned utterance embedding vector by using a continuous outlier detection technique, an outlier removal technique, or the like.

The device 1200 may determine whether input utterance information is included in a training database of the second encoder 1220. For example, the device 1200 may determine whether the input utterance information is included in the training database based on whether an utterance embedding vector mapped to the input utterance information is present. In some embodiments, the device 1200 may determine whether the input utterance information is included in the training database, based on speaker identification information that is input as utterance information. However, the determination is not limited thereto.

In a case in which the input utterance information is not included in the database, the device 1200 may use the input utterance information as unlearned utterance information to generate an unlearned utterance embedding vector. In a case in which the input utterance information is included in the database, the device 1200 may generate a learned utterance embedding vector based on the input utterance information. Generation of an unlearned utterance embedding vector may be performed by the first encoder 1210, and generation of a learned utterance embedding vector may be performed by the second encoder 1220.

For example, when previously learned speaker utterance information is input, the device 1200 may generate a learned utterance embedding vector by using the second encoder 1220. The device 1200 may obtain a learned utterance embedding vector by inputting the input learned utterance information into the second encoder 1220. In some embodiments, in response to the input learned utterance information, the device 1200 may obtain a learned utterance embedding vector previously generated by the second encoder 1220. Here, the input learned utterance information is at least one piece of utterance information corresponding to a speaker whose speech is learned, and may be utterance information corresponding to a structured data variable received by the device 1200, but is not limited thereto.

As another example, when utterance information of a speaker whose speech is not learned is input, the device 1200 may generate an unlearned utterance embedding vector by using the first encoder 1210. The device 1200 may obtain an unlearned utterance embedding vector by inputting the unlearned utterance information into the first encoder 1210. Here, the unlearned utterance information may correspond to a speech signal or a speech sample of the speaker whose speech is not learned, which is received by the device 1200, but is not limited thereto.

The unlearned utterance embedding vector may have the same dimensionality as the learned utterance embedding vector. That is, the utterance embedding vector generated by the first encoder 1210 may include an utterance embedding vector mapped to the same embedding space as the utterance embedding vector generated by the second encoder 1220.

The device 1200 may generate an unlearned utterance embedding vector based on unlearned utterance information. The device 1200 may generate a speech signal based on text in a particular natural language, and the unlearned utterance embedding vector. According to an embodiment, the device 1200 may generate a spectrogram by inputting a text embedding vector generated based on text and the unlearned utterance embedding vector into an artificial neural network model. For example, the device 1200 may generate a spectrogram by inputting the text embedding vector and the unlearned utterance embedding vector into the synthesizer 220.

The speech signal generated based on particular text and an unlearned utterance embedding vector may be a speech signal reflecting utterance features of a speaker that are not present in the training database of the second encoder 1220.

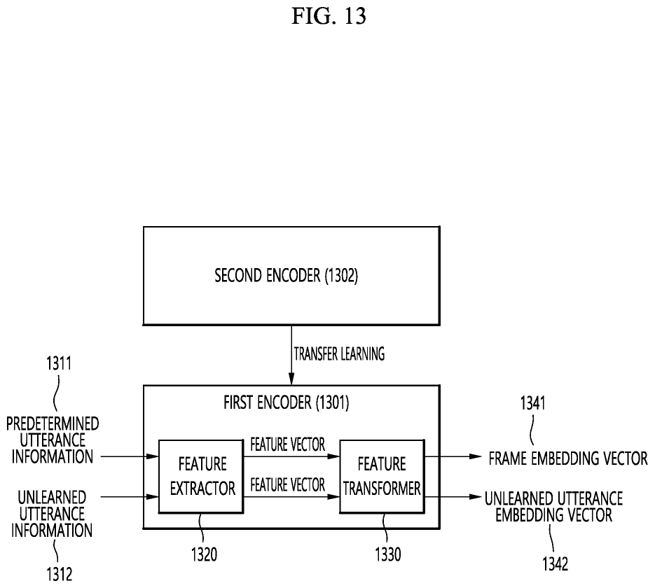

FIG. 13 is a diagram illustrating an embodiment of a first encoder configured to receive utterance information as input and generate an embedding vector. FIG. 13 is provided as a diagram for describing in detail an operation of the first encoder 1210 that is trained via transfer learning by using the second encoder 1220 illustrated in FIG. 12. A first encoder 1301 and a second encoder 1302 illustrated in FIG. 13 may correspond to the first encoder 1210 and the second encoder 1220 illustrated in FIG. 12, respectively.

Referring to FIG. 13, the device 1200 may perform transfer learning of the first encoder 1301 by inputting predetermined utterance information 1311 into the first encoder 1301 to obtain a frame embedding vector 1341. In addition, the device 1200 may synthesize a speech signal of a speaker whose speech is not learned, by inputting unlearned utterance information 1312 into the first encoder 1301 to obtain an unlearned utterance embedding vector 1342.

When performing transfer learning, the device 1200 may obtain a feature vector by inputting the predetermined utterance information 1311 into a feature extractor 1320 of the first encoder 1301. The feature extractor 1320 may include an algorithm based on an artificial neural network of which parameters are calibrated through backpropagation. In addition, the feature extractor 1320 may include an algorithm based on a signal processing technique, or an algorithm based on an artificial neural network of which parameters are not calibrated through backpropagation.

The feature extractor 1320 may include an algorithm based on a signal processing technique such as MFCC, mel-spectrogram, or linear spectrogram, but is not limited thereto. The feature extractor 1320 may include an algorithm based on an artificial neural network of which parameters have been determined through pre-training, such as wav2vec or HuBERT, but is not limited thereto. The device 1200 may generate a feature vector by inputting the unlearned utterance information 1312 into the feature extractor 1320 of the first encoder 1301 that is trained via transfer learning.

When performing transfer learning, the device 1200 may obtain the frame embedding vector 1341 by inputting a feature vector corresponding to the predetermined utterance information 1311 into a feature transformer 1330. The feature transformer 1330 may include an algorithm for mapping a feature vector to an embedding space such that the feature vector may be used for speech synthesis. For example, the feature transformer 1330 may include an MLP. In some embodiments, the feature transformer 1330 may include fully connected layers. The device 1200 may generate the unlearned utterance embedding vector 1342 by inputting the feature vector corresponding to the unlearned utterance information 1312 into the feature transformer 1330 of the first encoder 1301 that is trained via transfer learning.

The device 1200 may generate a speech signal of a speaker who is not included in training data, based on particular text and the unlearned utterance embedding vector 1342.

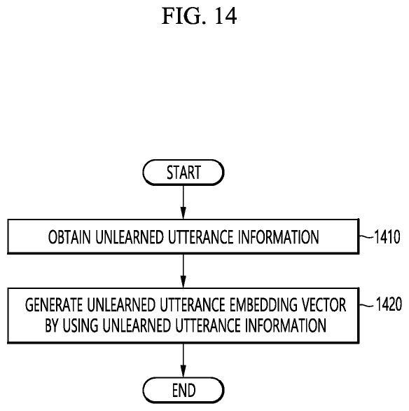

FIG. 14 is a flowchart of a method of synthesizing speech of a speaker whose speech is not learned, according to an embodiment.

Referring to FIG. 14, in operation 1410, the device 1200 may obtain unlearned utterance information.

In operation 1420, the device 1200 may generate an unlearned utterance embedding vector by using the unlearned utterance information. The generation may be performed by a first encoder that is trained via transfer learning. The first encoder may have been trained via transfer learning by using information output from a pre-trained second encoder.

For example, the transfer learning may be performed by the device 1200. In some embodiments, the transfer learning may be performed by a machine learning system independent of the device 1200. However, the subject performing transfer learning is not limited thereto.

According to an embodiment, the device 1200 may input predetermined utterance information obtained from a preset training database into the first encoder, to generate a feature vector for each of at least one speech frame into which the predetermined utterance information is divided.

According to an embodiment, the device 1200 may obtain a feature vector corresponding to a frame in which speech is present, among the speech frames.

According to an embodiment, the device 1200 may input the feature vectors into the first encoder to obtain frame embedding vectors for the respective feature vectors.

The device 1200 may calibrate parameters of the first encoder by using at least one of a target embedding vector, a frame embedding vector, and a feature vector output by the second encoder in response to the predetermined utterance information.

The first encoder may divide the utterance information into at least one speech frame, extract features of speech included in the speech frame, generate a feature vector for each speech frame, and generate a frame embedding vector for each feature vector in order to map the feature vector to an embedding space.

The device 1200 may calibrate the parameters by using at least one of a perceptual loss function and a triplet loss function.

The device 1200 may calculate a first loss based on a target embedding vector, a frame embedding vector, and the perceptual loss function.

The device 1200 may calibrate parameters based on the calculated first loss.

The device 1200 may obtain at least one comparative feature vector by inputting comparative utterance information different from the predetermined utterance information into the first encoder. The comparative utterance information may be obtained from a database. A first speaker corresponding to the comparative utterance information may be different from a second speaker corresponding to the predetermined utterance information.

The device 1200 may calculate the second loss based on one comparative feature vector selected among from the comparative feature vectors, two feature vectors selected from among feature vectors generated based on the predetermined utterance information, and the triplet loss function.

The device 1200 may calibrate parameters based on the calculated second loss.

Based on the unlearned utterance information, the device 1200 may generate a feature vector for each of at least one speech frame into which the unlearned utterance information is divided.

The device 1200 may generate an unlearned utterance embedding vector based on the feature vector.

The device 1200 may generate the same number of frame embedding vectors as the number of feature vectors, based on the feature vectors.

The device 1200 may generate an unlearned utterance embedding vector based on the frame embedding vector.

The device 1200 may determine whether input utterance information is included in a training database of the second encoder.

In a case in which the input utterance information is not included in the database, the device 1200 may use the input utterance information as unlearned utterance information to generate an unlearned utterance embedding vector, and in a case in which the input utterance information is included in the database, the device 1200 may generate a learned utterance embedding vector based on the input utterance information.

Generation of an unlearned utterance embedding vector may be performed by the first encoder, and generation of a learned utterance embedding vector may be performed by the second encoder.

The device 1200 may generate a speech signal based on text in a particular natural language, and the unlearned utterance embedding vector.

Related-art speech synthesis methods have many limitations in synthesizing natural speech reflecting an utterance style or an emotional expression of a speaker. Accordingly, recently, a speech synthesis method for synthesizing speech from text based on an artificial neural network has been spotlighted. An artificial neural network-based multi-speaker speech synthesis system synthesizes speech by imitating utterance features of a speaker that are learned.

In order for a general multi-speaker speech synthesis system to synthesize speech with a voice of a speaker whose speech is not learned, which is not included in training data, it is necessary to expand weights of an encoder model, build a training dataset for the speaker whose speech is not learned, and then perform additional training through fine-tuning.

However, because expanding the weights of the model and building a new training dataset entail considerable expense, and there is a possibility that the quality of generation of speech of a speaker whose speech is previously learned may deteriorate during a fine-tuning operation, there is a need for a technology for synthesizing speech of a speaker whose speech is not learned, while maintaining the quality of synthesized speech of a speaker whose speech is previously learned.

According to the method and device for synthesizing speech of a speaker whose speech is not learned described above with reference to FIGS. 12 to 14, it is possible to synthesize speech of a speaker who is not included in existing training data of an encoder, thereby increasing the number of speakers whose speech may be synthesized.

In addition, because a fine-tuning operation may be omitted, the number of speakers whose speech may be economically synthesized may be increased.

In addition, the reusability of a speech synthesis system may be increased, and version management of a speech synthesis model may be facilitated.

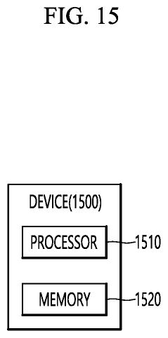

FIG. 15 is a block diagram of a device according to an embodiment of the present disclosure. A device 1500 illustrated in FIG. 15 may correspond to the speech synthesis system 200 illustrated in FIG. 2, the device 600 illustrated in FIG. 6, the device 900 illustrated in FIG. 9, or the device 1200 illustrated in FIG. 12.

Referring to FIG. 15, the device 1500 includes a processor 1510 and a memory 1520, thereby implementing the speech synthesis system 200, the device 600, the device 900, or the device 1200. FIG. 15 illustrates only components of the device 1500 that are associated with the embodiment, and thus, those of skill in the art may understand that the device 1500 may further include other general-purpose components in addition to the components illustrated in FIG. 15.

The processor 1510 controls the overall operation of the device 1500. For example, the processor 1510 may execute programs stored in the memory 1520 to control the overall operation of an input unit (not shown), a display (not shown), a communication module (not shown), the memory 1520, and the like, and to control the operation of the device 1500.

For example, the processor 1510 may generate an initial embedding vector based on predetermined utterance information, generate a low-dimensional embedding vector by reducing the dimensionality of the initial embedding vector by using a predetermined dimensionality reduction technique, adjust component values of the low-dimensional embedding vector based on a user input, and generate a modified embedding vector by restoring the dimensionality of the low-dimensional embedding vector of which the component values are adjusted.

A detailed example of an operation of the processor 1510 is the same as that described above with reference to FIGS. 1 to 14. Thus, detailed descriptions of the operation of the processor 1510 will be omitted.

The processor 1510 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

The memory 1520 is hardware for storing various pieces of data processed by the device 1500, and may store a program for the processor 1510 to perform processing and control.

The memory 1520 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

In addition, embodiments of the present disclosure may be implemented as a computer program that may be executed through various components on a computer, and such a computer program may be recorded in a computer-readable medium. In an embodiment, the computer program may be recorded on a non-transitory computer-readable recording medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

In addition, the operations of all methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skill in the art without departing from the spirit and scope of the present disclosure.

Therefore, the spirit of the present disclosure should not be limited to the above-described embodiments, and all modifications and variations which may be derived from the meanings, scopes and equivalents of the claims should be construed as failing within the scope of the present disclosure.

According to the above-described embodiment of the present disclosure, speech of numerous speakers in addition to a speaker whose speech is learned may be synthesized, and the application area of a speech synthesis system may be expanded.

In addition, according to another embodiment of the present disclosure, utterance features may be modified by arbitrarily modifying an embedding vector of a speaker whose speech is learned, and infinite speech with different features may be synthesized.

In addition, according to another embodiment of the present disclosure, the identity of a speaker who provided training data may be protected by synthesizing speech with a voice of a non-existent speaker.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of synthesizing speech with modified utterance features, the method comprising:
generating an initial embedding vector based on predetermined utterance information;
generating a low-dimensional embedding vector by reducing dimensionality of the initial embedding vector by using a predetermined dimensionality reduction technique;
adjusting a component value of the low-dimensional embedding vector based on a user input; and
generating a modified embedding vector by restoring dimensionality of the low-dimensional embedding vector of which the component value is adjusted.

2. The method of claim 1, wherein the predetermined dimensionality reduction technique is based on principal component analysis (PCA) using component values of the initial embedding vector.

3. The method of claim 1, wherein the generating of the low-dimensional embedding vector comprises:
generating a first reduced vector by reducing the dimensionality of the initial embedding vector; and
generating a second reduced vector having fewer dimensions than the first reduced vector, by reducing dimensionality of the first reduced vector.

4. The method of claim 1, wherein the adjusting of the component value comprises adjusting the component value of the low-dimensional embedding vector by generating a first interface for displaying the component value of the low-dimensional embedding vector and receiving the user input through the first interface.

5. The method of claim 1, wherein the adjusting of the component value comprises adjusting the component value of the low-dimensional embedding vector by:
mapping at least one utterance feature extracted from the predetermined utterance information, to the component value of the low-dimensional embedding vector; and
generating a second interface for displaying the mapped at least one utterance feature, and receiving the user input for adjusting the at least one utterance feature through the second interface.

6. The method of claim 1, wherein the adjusting of the component value comprises adjusting the component value of the low-dimensional embedding vector to be between a first threshold value and a second threshold value, the first threshold value and the second threshold value being inclusive, based on the user input, and
the first threshold value is less than the second threshold value.

7. The method of claim 1, wherein the predetermined dimensionality reduction technique comprises a technique for dimensionality restoration using an inverse operation, and
the generating of the modified embedding vector comprises generating the modified embedding vector by performing an inverse operation of an operation of generating the low-dimensional embedding vector by using the predetermined dimensionality reduction technique.

8. The method of claim 1, further comprising generating a speech signal based on text in a particular natural language, and the modified embedding vector.

9. A device for synthesizing speech with modified utterance features, the device comprising:
a memory storing at least one program; and
a processor configured to operate by executing the at least one program,
wherein the processor is further configured to generate an initial embedding vector based on predetermined utterance information, generate a low-dimensional embedding vector by reducing dimensionality of the initial embedding vector by using a predetermined dimensionality reduction technique, adjust a component value of the low-dimensional embedding vector based on a user input, and generate a modified embedding vector by restoring dimensionality of the low-dimensional embedding vector of which the component value is adjusted.

10. A non-transitory computer-readable recording medium having recorded thereon a program for causing a computer to execute the method of claim 1.
